(19) United States
(12) Patent Application Publication
(10) Pub. No.: US 2011/0282713 A1
(43) Pub. Date: Nov. 17, 2011

(54) PRODUCT POSITIONING AS A FUNCTION OF CONSUMER NEEDS

(76) Inventors: Henry BRUNELLE, Quebec (CA); Louis GENDREAU, Sainte-Marie (CA)

(21) Appl. No.: 12/779,509

(22) Filed: May 13, 2010

(51) Int. Cl. G06Q 10/00

(52) U.S. Cl. 705/7.32

(57) ABSTRACT

There is described a computer-implemented method for evaluating a living environment having a plurality of elements therein, the method comprising: presenting, via a user interface, a first series of questions, the questions being divided into at least three first categories, each first category having at least one question associated thereto, each question having a plurality of answers with varying weights associated thereto, each first category corresponding to an aspect of the living environment; storing in a memory received answers for the first series of questions; and using a processor for: calculating, for each first category, a score as a function of received answers and associated weights; positioning the score for each first category as a point on a corresponding axis in a first multi-dimensional coordinate system, the intersection of all axes representing a score of 100% and each axis having progressively decreasing values extending from the intersection; creating a surface in the first multi-dimensional coordinate system by joining the points on each axis together, the size and shape of the surface representing a degree to which each aspect of the environment is met; and outputting the surface to the user interface.

### CROSS-REFERENCE TO RELATED APPLICATIONS

This is the first application filed for the present invention.

### TECHNICAL FIELD

The present invention relates to the field of software tools used by merchants and consumers for evaluating the needs of a potential customer, and illustrating how one or a series of products can meet those needs.

### BACKGROUND OF THE ART

In a competitive market place, one way to gain an advantage is to offer products that are superior to your competitors' products. However, when the consumer is not sophisticated, the quality of the product itself may be hard to ascertain and the competitive edge needs to be gained by some other means.

Lower prices and better marketing may be used to gain the attention of the consumer, but eventually, even these advantages may be lost or somehow matched by the competitor.

There is a need for a means to determine what the consumer really wants or needs, and how to best present a product or series of products as a function of these needs.

### SUMMARY OF THE SPECIFICATION

There is described herein a software tool used by merchants to position their products as a function of a customer's present living environment and his or her needs. The living environment and needs of the customer are determined by selecting a set of criteria, providing a set of questions having answers that are weighted accordingly, and defining a surface or volume from the answers. The products or series of products are then mapped onto the space using a second set of criteria, for the customer to see how each product or series of products meets the various criteria.

A first step involves an evaluation of the individual's present environment and needs. A first set of criteria is used to evaluate the present environment and the needs of the individual and determine how efficiently it meets a balance between these criteria, thereby defining a space representing the present environment.

This step may be done using a series of questions for each one of the criteria, each possible answer having a predetermined weight assigned thereto. These questions are answered by the potential customer.

A second step involves positioning the different products or series of products available within the space defined by the evaluation of the environment. A second set of criteria is used to do so. The products or series of products are mapped by the merchant inside the space using another series of questions (answered by the merchant) with their own set of weights assigned thereto.

The customer may then select a product knowing that it will have a larger impact on a given criteria, as a function of its position in the space.

In accordance with a first broad aspect, there is provided a computer-implemented method for evaluating a living environment having a plurality of elements therein, the method comprising: presenting, via a user interface, a first series of questions, the questions being divided into at least three first categories, each first category having at least one question associated thereto, each question having a plurality of answers with varying weights associated thereto, each first category corresponding to an aspect of the living environment; storing in a memory received answers for the first series of questions; and using a processor for: calculating, for each first category, a score as a function of received answers and associated weights; positioning the score for each first category as a point on a corresponding axis in a first multi-dimensional coordinate system, the intersection of all axes representing a score of 100% and each axis having progressively decreasing values extending from the intersection; creating a surface in the first multi-dimensional coordinate system by joining the points on each axis together, the size and shape of the surface representing a degree to which each aspect of the environment is met; and outputting the surface to the user interface.

In accordance with a second broad aspect, there is provided a computer system for evaluating a living environment having a plurality of elements therein, comprising: a user interface for presenting a first series of questions, the questions being divided into at least three first categories, each first category having at least one question associated thereto, each question having a plurality of answers with varying weights associated thereto, each first category corresponding to an aspect of the living environment; a memory for storing received answers for the first series of questions; a processor; and an application coupled to the processor and configured for: calculating, for each first category, a score as a function of received answers and associated weights; positioning the score for each first category as a point on a corresponding axis in a first multi-dimensional coordinate system, the intersection of all axes representing a score of 100% and each axis having progressively decreasing values extending from the intersection; creating a surface in the first multi-dimensional coordinate system by joining the points on each axis together, the size and shape of the surface representing a degree to which each aspect of the environment is met; and outputting the surface to the user interface.

In accordance with a third broad aspect, there is provided a computer readable memory having recorded thereon statements and instructions for execution by a computer to carry out a method for evaluating a living environment having a plurality of elements therein, the statements and instructions being directed to: presenting, via a user interface, a first series of questions, the questions being divided into at least three first categories, each first category having at least one question associated thereto, each question having a plurality of answers with varying weights associated thereto, each first category corresponding to an aspect of the living environment; calculating, for each first category, a score as a function of received answers and associated weights; positioning the score for each first category as a point on a corresponding axis in a first multi-dimensional coordinate system, the intersection of all axes representing a score of 100% and each axis having progressively decreasing values extending from the intersection; creating a surface in the first multi-dimensional coordinate system by joining the points on each axis together, the size and shape of the surface representing a degree to which each aspect of the environment is met; and outputting the surface to the user interface.

In this specification, the term “living environment” is intended to mean any space, indoors or outdoors, having a given shape or form, with components therein for functional and/or aesthetic purposes, in which an individual may spend any portion of his or her time during a day. While the present description may sometimes refer to a bathroom as an exemplary living environment, it should be understood that this example is simply illustrative and should not be construed in a restrictive manner.

### BRIEF DESCRIPTION OF THE DRAWINGS

Further features and advantages of the present invention will become apparent from the following detailed description, taken in combination with the appended drawings, in which:

FIG. 1 is a flowchart illustrating one embodiment of a method for evaluating a living environment having a plurality of elements therein;

FIG. 2A is an exemplary screenshot of a user interface presenting questions to a user for a first category;

FIG. 2B is an exemplary screenshot of a user interface presenting questions to a user for a second category;

FIG. 2C is an exemplary screenshot of a user interface presenting questions to a user for a third category;

FIG. 3A is an exemplary screenshot of answers and scoring for the questions of FIG. 2A;

FIG. 3B is an exemplary screenshot of answers and scoring for the questions of FIG. 2B;

FIG. 3C is an exemplary screenshot of answers and scoring for the questions of FIG. 2C;

FIG. 4A is an exemplary three-dimensional coordinate system for the surface;

FIG. 4B is an exemplary six-dimensional coordinate system for the surface;

FIG. 4C illustrates positioning of scores in the three-dimensional coordinate system of FIG. 4A;

FIG. 4D illustrates positioning of scores in the six-dimensional coordinate system of FIG. 4B;

FIG. 5A is an exemplary surface on the three-dimensional coordinate system of FIG. 4A;

FIG. 5B is an exemplary surface on the six-dimensional coordinate system of FIG. 4B;

FIG. 6 is a flowchart illustrating the method of FIG. 1 with a step of superimposing a mapping of products on the surface, in accordance with one embodiment;

FIG. 7 is an flowchart illustrating an embodiment for the step of superimposing a mapping of products on the surface;

FIG. 8A is an exemplary screenshot of a user interface presenting questions to a merchant regarding a product for a first category;

FIG. 8B is an exemplary screenshot of a user interface presenting questions to a merchant regarding a product for a second category;

FIG. 8C is an exemplary screenshot of a user interface presenting questions to a merchant regarding a product for a third category;

FIG. 9A is an exemplary screenshot of answers and scoring for the questions of FIG. 8A;

FIG. 9B is an exemplary screenshot of answers and scoring for the questions of FIG. 8B;

FIG. 9C is an exemplary screenshot of answers and scoring for the questions of FIG. 8C;

FIG. 10 is an exemplary schematic illustrating a mapping of products in a three-dimensional coordinate system;

FIG. 11 is an exemplary schematic illustrating superimposing the mapping of products from FIG. 10 onto the surface of FIG. 5A;

FIG. 12 is an exemplary embodiment of a computer system for evaluating a living environment having a plurality of elements therein; and

FIG. 13 is an exemplary embodiment of an application of the computer system of FIG. 12.

It will be noted that throughout the appended drawings, like features are identified by like reference numerals.

### DETAILED DESCRIPTION

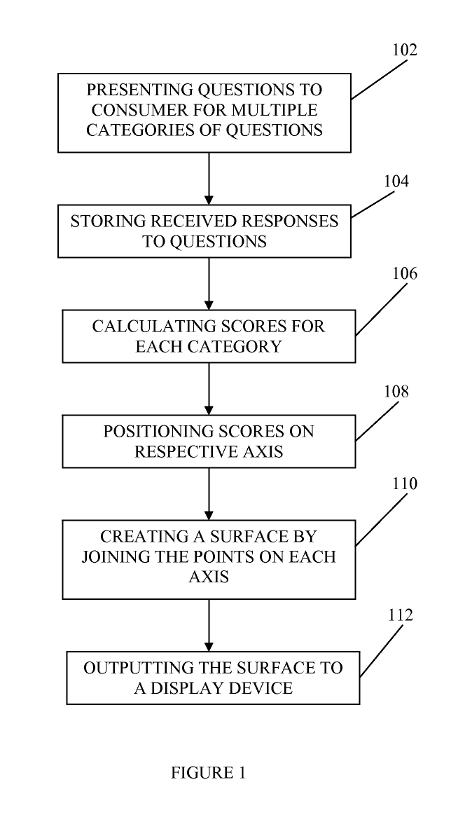

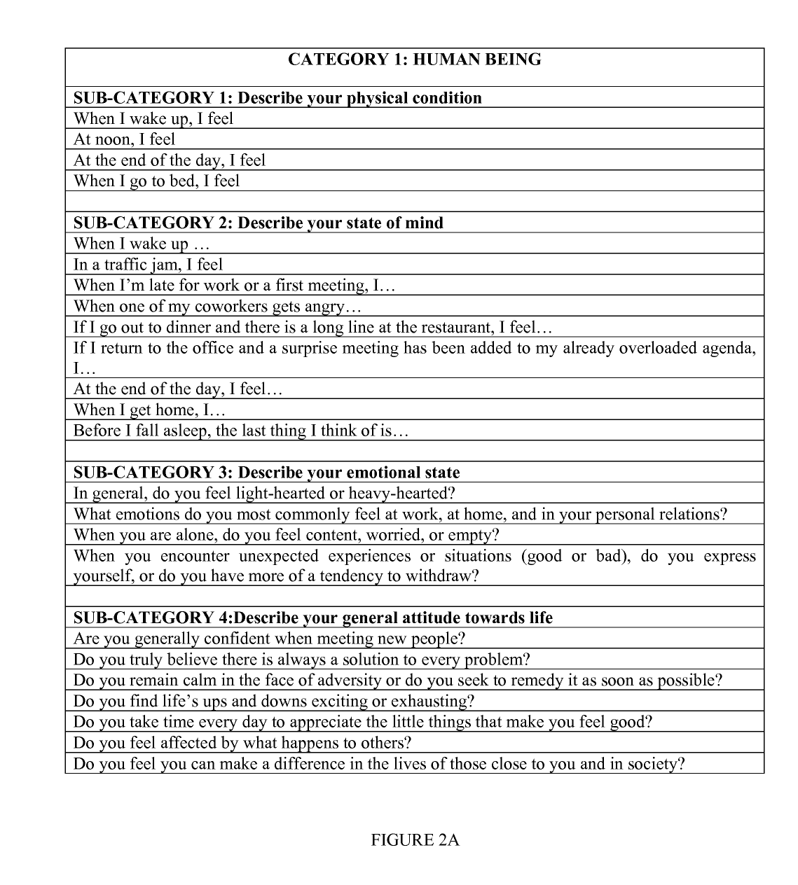

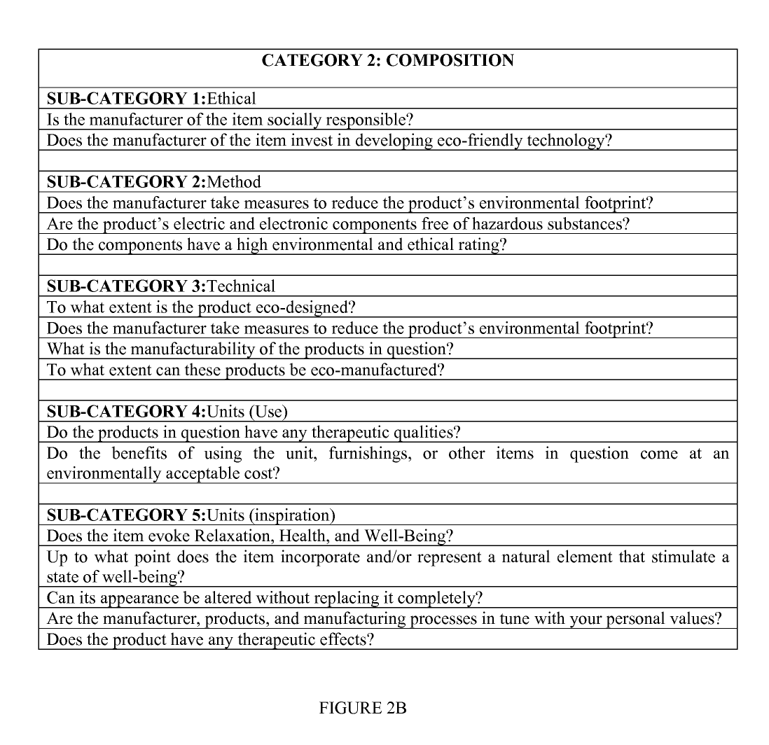

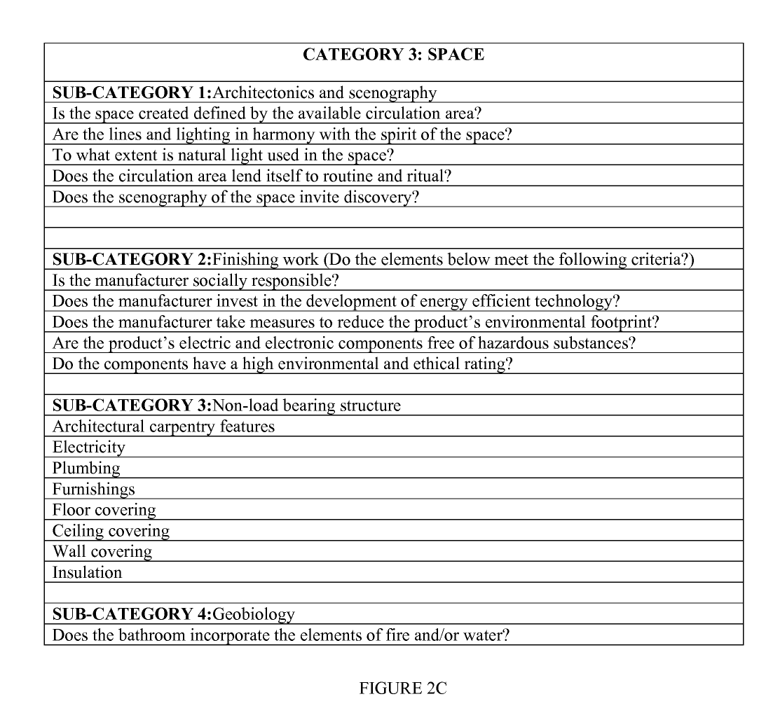

Referring to FIG. 1, there is illustrated a method for evaluating a living environment having a plurality of elements therein. A first step of the method comprises presenting questions to a consumer 102. The questions may be separated into a plurality of categories and are intended to evaluate the different aspects of the living environment. The questions may be grouped into two or more categories, and each category may have a further break-down of sub-categories. The questions may be in the form of text, as illustrated in FIGS. 2a, 2b, and 2c, or may be presented in the form of images, video, etc, in order to illicit a response in the form of an answer.

Exemplary illustrations of a set of categories with sub-categories are shown in the screenshots of FIGS. 2a, 2b, and 2c. FIG. 2a shows a sample of questions for a first category entitled “human being” and having questions which relate to physical, mental, emotional, and energetic aspects of the living environment. FIG. 2b shows a sample of questions for a second category entitled “composition” and having questions related to the area and layout of the living environment. FIG. 2c shows a sample of questions for a third category having questions related to the contents of the living environment.

The first category, as shown in FIG. 2a, is further broken down into four sub-categories, with questions in each one of the sub-categories having a common theme or topic. For example, sub-category 1 relates to a physical condition, and the questions therein are directed towards a physical feeling felt at different times of the day. Sub-category 2 relates to a state of mind, and the questions therein are directed towards the state of mind of an individual at different times of the day and/or when certain events occur during the day. Questions such as “In a traffic jam, I feel . . . ” and “At the end of the day, I feel . . . ” are meant to illicit a response related to how the individual's state of mind changes depending on a time or an event of the day. Sub-category 3 relates to an emotional state, and the questions therein are directed towards how an emotional response felt by an individual in general and/or in a specific context. Sub-category 4 relates to general attitudes towards life, and the questions therein are directed towards an individual's behavior and/or perspectives regarding general or specific situations. All of the questions found in the first category are directed towards the individual in order to get a sense of behaviors, attitudes, perspectives, and/or emotional/physical responses of the individual in general and/or specific situations. The answers to these questions are helpful in drawing an emotional and physical portrait of the individual.

The second category, as shown in FIG. 2b, is further broken down into five sub-categories, with questions in each one of the sub-categories having a common theme or topic. The questions may be answered only once by considering the items or elements already present in the living environment as a whole, or they may be answered multiple times, once for each item or element individually. Examples of items are decorative (curtains, a painting, a picture frame, etc), functional (a sink, a countertop, a table, a chair, a shower, a bath, etc), or both (a clock, a carpet, a light fixture, blinds, etc).

In this example, sub-category 1 relates to a ethics, and the questions therein are directed towards how the individual thinks about certain ethical questions relating to an item found in the present living environment. Sub-category 2 relates to methods used to make or produce the items. Sub-category 3 relates to technical questions having to do with the design of the item. Sub-category 4 relates to therapeutic benefits that may be gained from the items. Sub-category 5 relates to values and inspirational aspects of the items. All of the questions found in the second category are directed towards the individual elements making up the living environment, and may be related to the make-up of the item, the benefits of the item, the drawbacks of the item, and/or the design of the item.

The third category, as illustrated in FIG. 2c, relates to the area and layout of the environment. In this example, sub-category 1 has questions directed to structural design and perspectives (architectonics & scenography). Sub-category 2 has questions that relate to ethical and social aspects of the space. Sub-category 3 has questions that relate to specific structures found in the space, and sub-category 4 has questions relating to geobiology.

As illustrated in these screenshots, the number of categories, sub-categories, and questions may vary. The nature of the questions may also vary. In this particular example, the categories are chosen to cover the three main components of a living environment: the individual who resides in it (human-being), the elements that are present in it (composition), and the lay-out or design of it (space). The questions presented to the user are selected in order to better understand the individual's needs and how he or she is driven to make some of the choices that led to the make-up of the present living environment. The questions are also chosen to evaluate the present living environment using various criteria that are deemed important for the general well-being of a person.

In one embodiment, multiple-choice type answers are presented to the user using a Likert scale, whereby answers are given on a scale ranging from complete agreement on one side to complete disagreement on the other side. Alternatively, a numerical scale may used. In yet another embodiment, predefined answers are presented and the user is asked to select the answer that is most suitable for him or her. Other types of answer format may be used. In addition, a combination of various answer formats, such as Likert scale for some questions and predefined answers for other questions, may be used. In some instances, the questions may be yes/no types while in other instances, the questions may have anywhere from 3 to N possible answers.

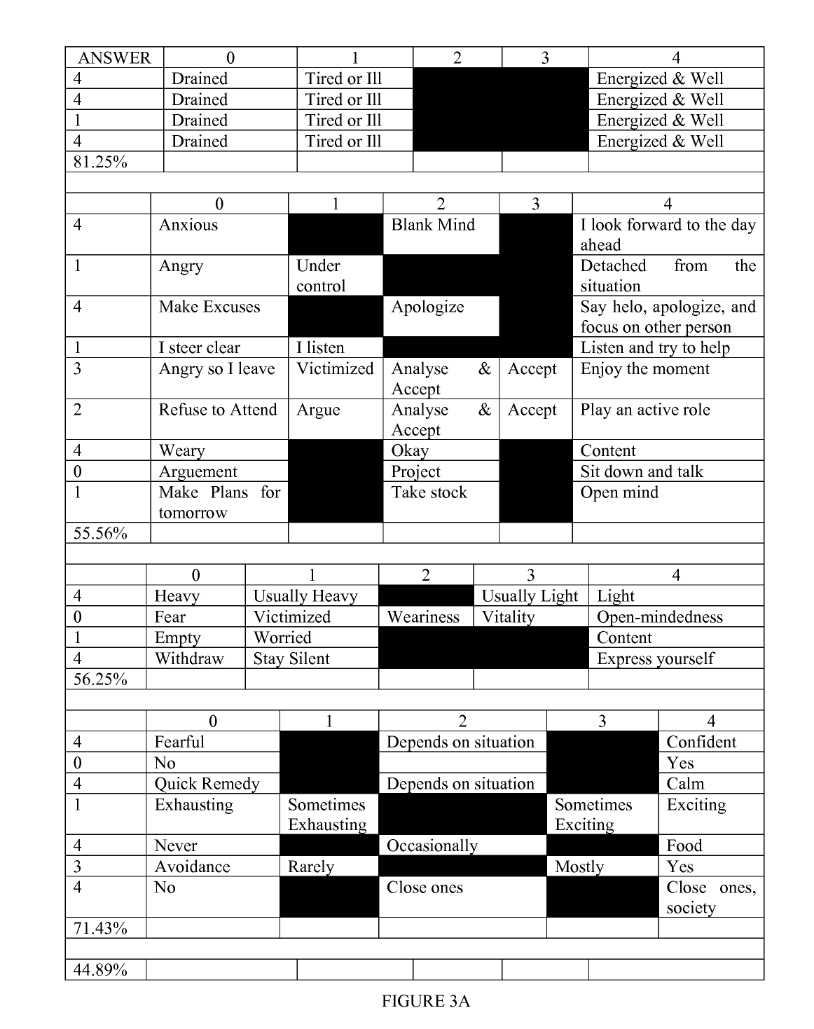

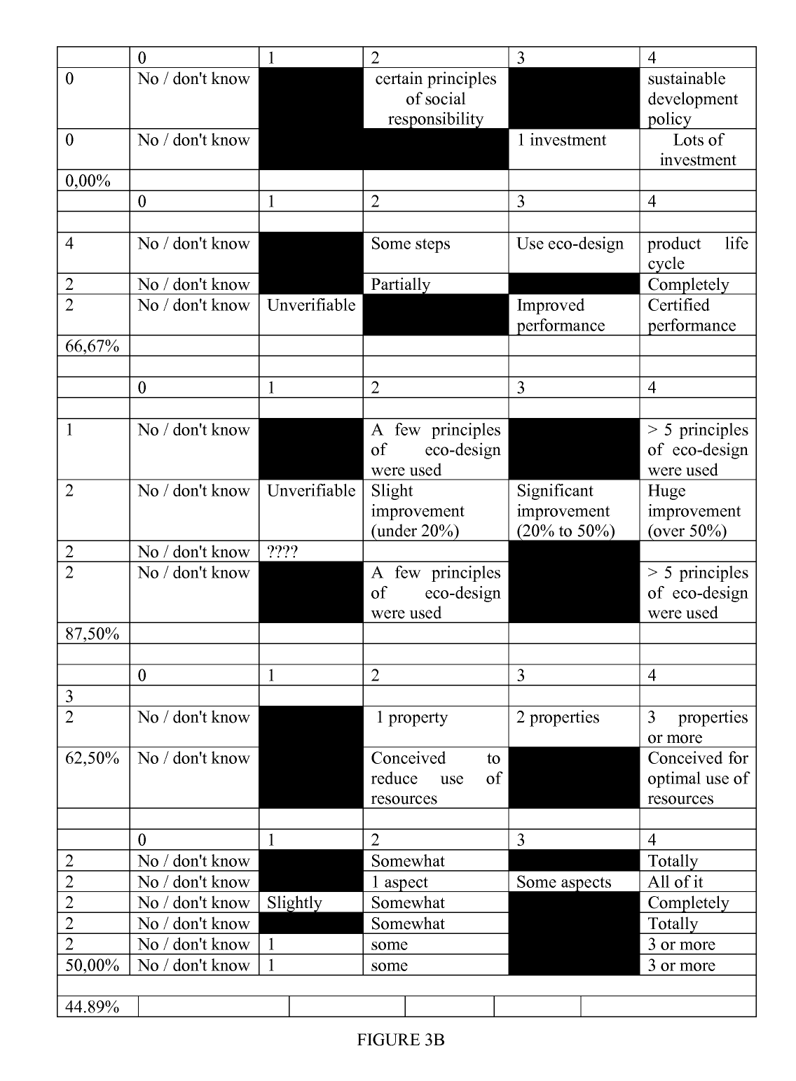

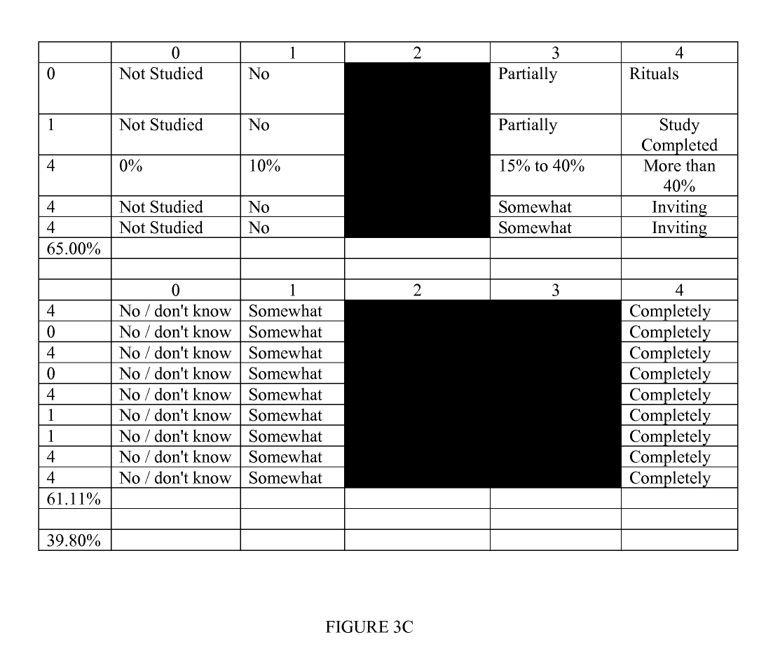

FIGS. 3a, 3b, and 3c illustrate an exemplary format for answers and scoring. In this example, a maximum number of five answers are available, with some questions having less than five answers available. The blacked out boxes illustrate an unavailable answer. This may be done to provide a more significant difference between a first answer and a second answer when a weighting system is associated with the various answers in order to calculate a score. For example, if a weight of 0 to 4 is given to each answer, not having an available answer for weights 1, 2, and 3 will give a bigger difference between an answer at position 0 and an answer at position 4.

The questions of sub-category 1 in FIG. 2a are associated with the first block of possible answers in FIG. 3a. In this case, the questions are directed towards how the individual feels at certain moments of the day. The possible answers are drained (0), tired or ill (1), and energized and well (4). In the illustrated example, questions 1, 2, and 4 received an answer of “4” while question 3 received an answer of “1”. The following formula is used to calculate the score of 81.25%: ((A1+A2+A3+A4)/(4*4))*100=((4+4+1+4)/(4*4))*100=81.25% (or 0.8125 if not presented in percentage).

In a more generalized form, the equation is:

((A1+A2+ . . . +AN)/(highest value of scale*N))*100

Similarly, the second block of possible answers and score are associated with the questions of sub-category 2 from FIG. 2a. In this case, there are nine questions (and received answers). Some questions have unavailable answers. The highest value of the scale is still four. Therefore, using the answers in the illustrated example, the score is calculated as: ((4+1+4+1+3+2+4+0+1)/(4*9))*100=55.56%. This process is repeated for the questions found in the other sub-categories of FIG. 2a, as well as those found in FIGS. 2b, and 2c, using the corresponding answer blocks found in FIGS. 3a, 3b, and 3c.

It will be understood that the scoring format described above is exemplary and may be replaced by another equivalent format for obtaining a score from a set of answers. For example, answers from 0 to 4 may be given an equivalent weight varying from 0% to 100%, and the totals added up and divided by the number of questions to provide an average score. Another alternative scoring format that may be used consists in assigning a predetermined weight to each answer that takes into account the number of questions and the number of possible answers. Yet another alternative scoring format is to average out the scores by squaring the square root of the sum each score from each sub-category. Other alternatives may also be used.

Referring back to FIG. 1, the second step of the method is to store received responses to the questions 104. Using the received responses, scores are calculated for each category 106, as previously illustrated. These scores are then positioned on a corresponding axis in a multi-dimensional coordinate system. The number of dimensions to the coordinate system corresponds to the number of categories previously selected for the set of questions. For example, in an embodiment with three categories as illustrated in FIGS. 2a, 2b, and 2c, the scores would be positioned in three corresponding axes in a three-dimensional coordinate system.

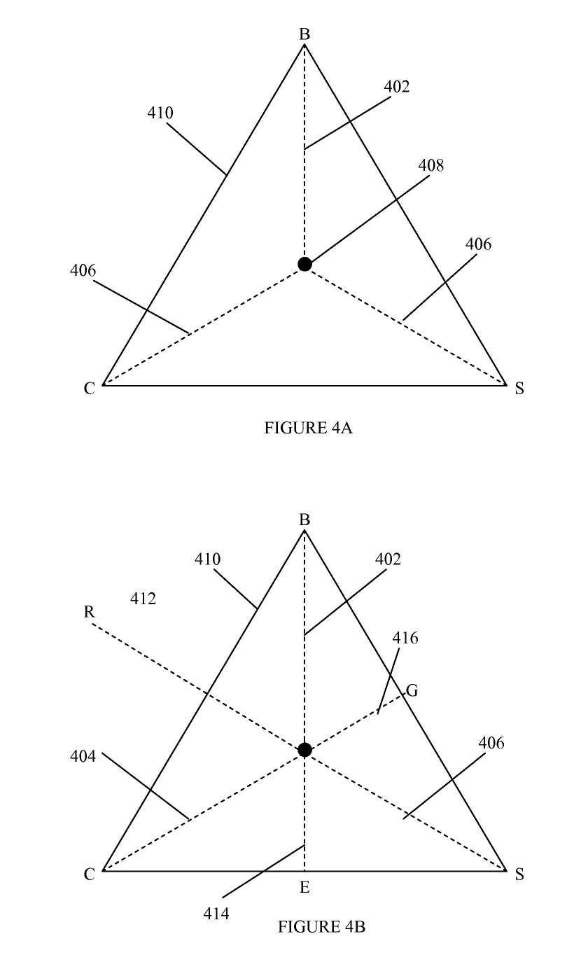

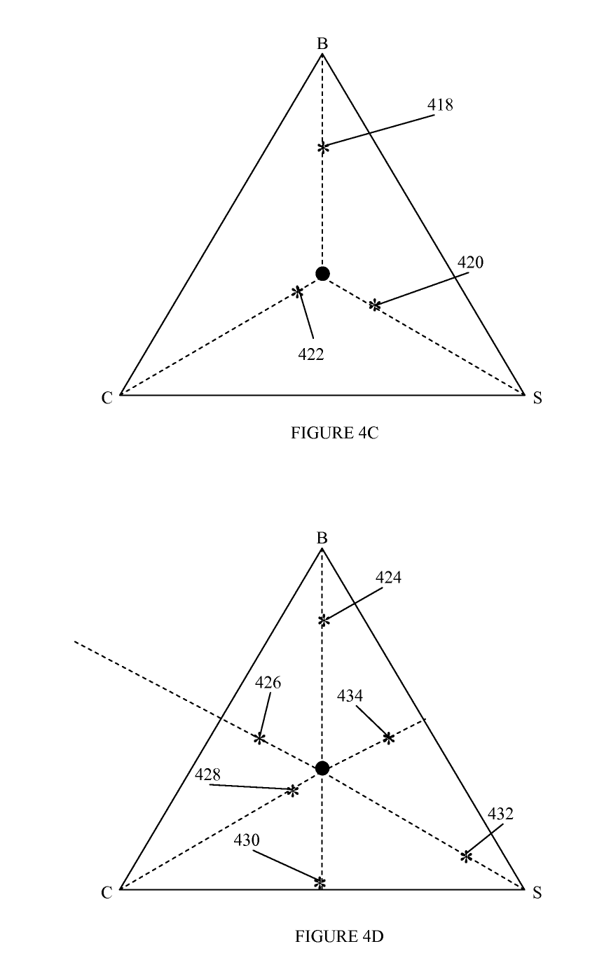

FIG. 4a illustrates an exemplary three-dimensional coordinate system. The three axes 402, 404, 406 represent the three categories Being, Composition, and Space, respectively. The intersection point 408 of the three axes 402, 404, 406 is the center of the coordinate system and corresponds to a score of 100%. The axes 402, 404, 406 therefore have progressively decreasing values that extend from the intersection point 408. A triangle 410 illustrates a surface formed by connecting the end points (0%) of each axis together. This surface represents a score of 0% for each category of the questions presented in FIGS. 2a, 2b, 2c.

FIG. 4B is an alternative embodiment of a multi-dimensional coordinate system. In this example, there are six categories of questions and therefore six axes, 402, 404, 406, 412, 414, 416. A fourth exemplary category (E) includes questions related to lighting effects, circulation, and movement of the living environment. A fifth exemplary category (R) includes questions related to media elements in the environment. A sixth exemplary category (G) includes questions related to magnetic and electrostatic fields in the environment. Corresponding axes 414, 412, and 416, respectively, are therefore present in the multi-dimensional coordinate system illustrated in FIG. 4b.

In one embodiment, the axes 412, 414, 416 are scaled such that their intersection point with the previously drawn triangle 410 corresponds to a score of 0%, thereby keeping a total score of 0% within the confines of the triangle 410.

In another embodiment, one or more of the axes 412, 414, 416 may go beyond the intersection point of the triangle to indicate a negative score, with its end point being −100%. In the example illustrated in FIG. 4b, axis 412 is shown to go beyond the confines of the triangle 410. This may be used to show a negative incidence of a particular element on the present living environment. For example, the presence of a telecommunications medium, such as a television, a computer, or a telephone, in the living environment may be considered negative and this impact is illustrated with a negative score and therefore a negative point on the axis 412.

The questions for categories beyond those illustrated in FIGS. 2a, 2b, and 2c may be taken from the already presented categories to form the new categories, or additional questions and/or categories may be created to complement those previously illustrated.

FIG. 4c illustrates the coordinate system of FIG. 4a with each score 418, 420, 422 for a given category positioned on the respective axis. Similarly, FIG. 4d illustrates the coordinate system of FIG. 4b with each score 424, 426, 428, 430, 432, 434 for a given category positioned on the respective axis.

Referring back to FIG. 1, once the scores are positioned on the axis, a surface is created in the multi-dimensional coordinate system 110 by joining the points on each axis together, the size and shape of the surface representing a degree to which each aspect of the environment is met. The surface may be output to a display device 112.

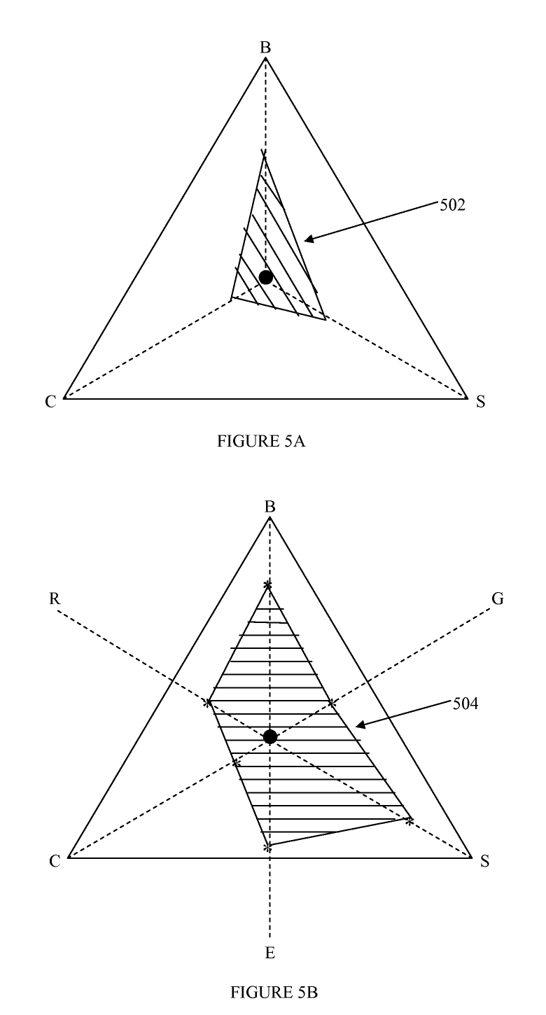

FIG. 5a illustrates the surface created from the points positioned as in FIG. 4c. In this example, the surface is a triangular surface having three vertices. FIG. 5B illustrates the surface created from the points positioned as in FIG. 4d. In this example, the surface is a polygon with six vertices.

Given that the center of the coordinate system represents a score of 100%, the shape and disposition of the surface illustrates which areas of the living environment need work. For example, with respect to the surface found in FIG. 5b, the surface covers a large part of the triangle 410 along the S axis 406. In the evaluation of the living environment, this may be an indicator that the Space component of the living environment is more in need of changes or modifications, compared to the elements found in the living environment (Composition component, axis 404). The ideal resulting surface, indicative of a perfectly balanced living environment for a given individual, is a single dot found in the center of the coordinate system. As the surface gets larger, problem areas are illustrated and the evaluation may lead to a conclusion that certain specific components or aspects of the living environment need improvement.

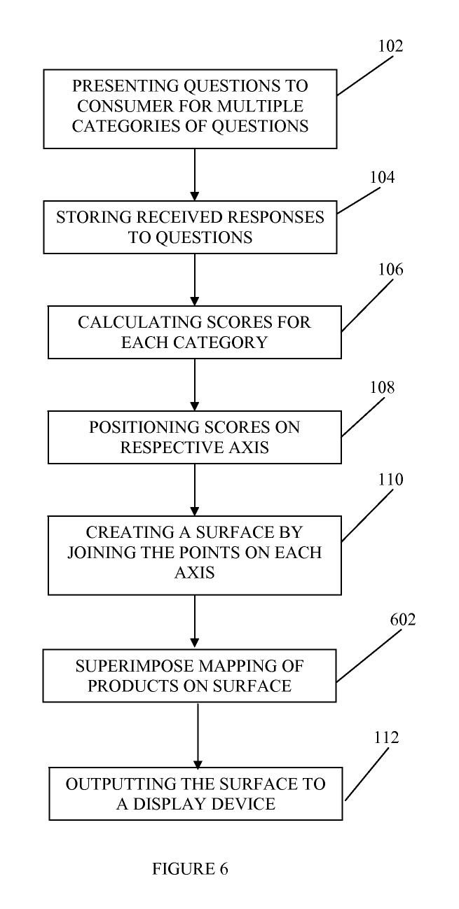

FIG. 6 illustrates another embodiment for the method of evaluating a living environment. In this embodiment, the evaluation is done in comparison to a product or a series of products available for the living environment. In order to do this comparison, a mapping of the products is super-imposed onto the surface created 602.

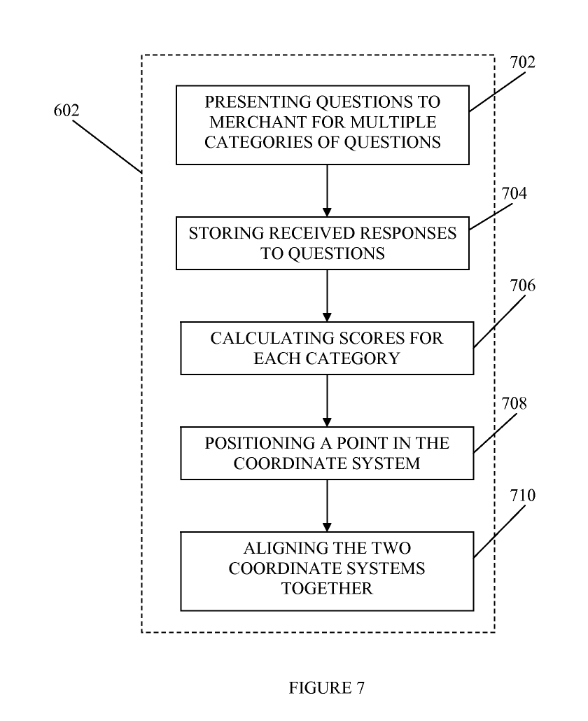

FIG. 7 is a flowchart illustrating one embodiment for mapping the products and super-imposing the mapping onto the surface. The method is similar to that presented above for evaluating the living environment in that a series of questions broken down into a plurality of categories are presented to a merchant 702, and received responses to the questions are stored 704. Also similarly, scores are calculated for each category 706.

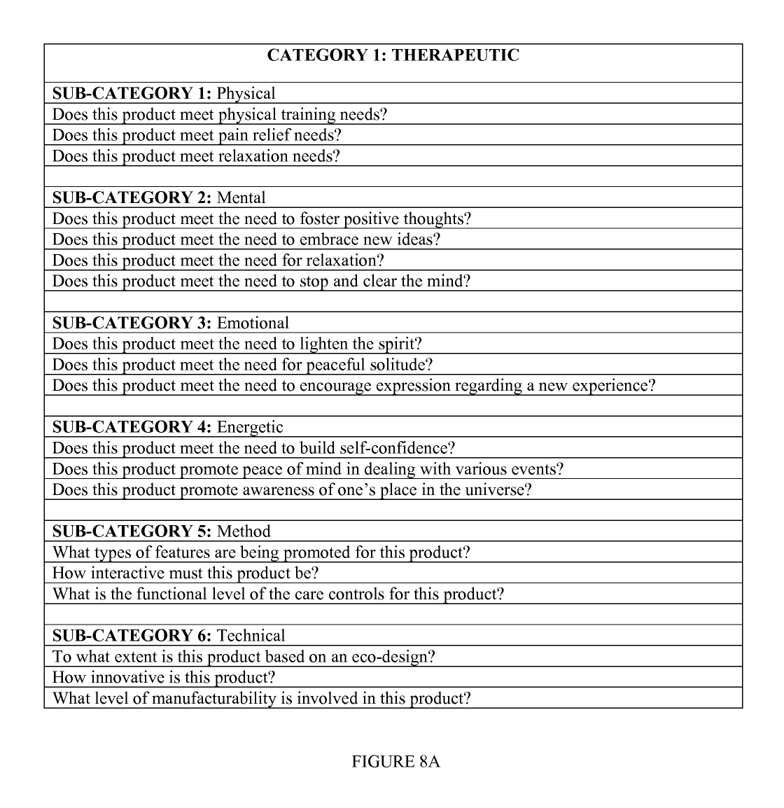

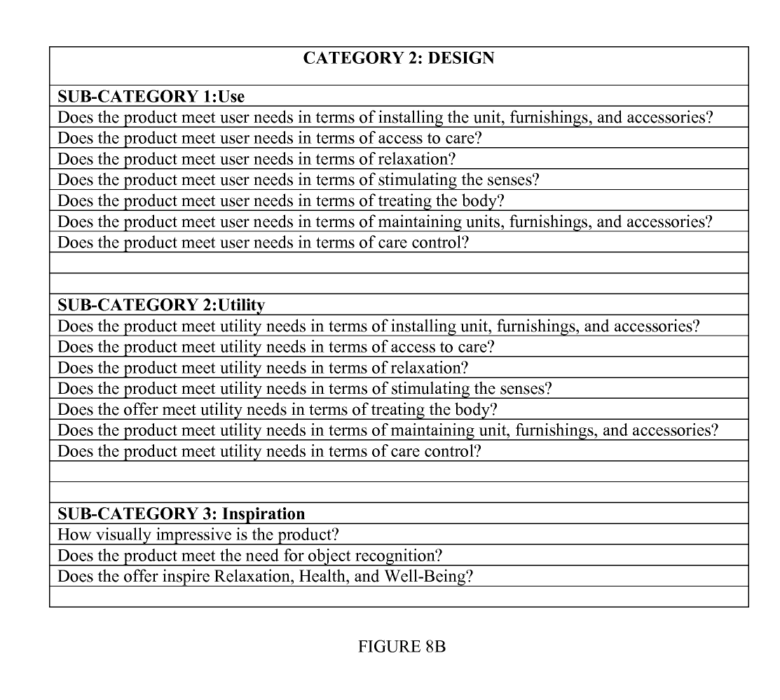

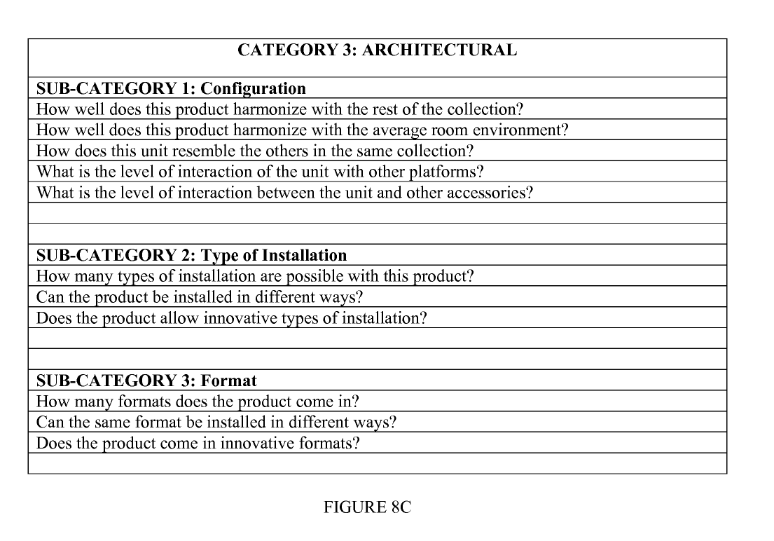

FIGS. 8a, 8b, and 8c illustrate exemplary categories, sub-categories, and questions for mapping the products. These questions are to be answered by either a manufacturer of the product or a merchant of the product. They are generally directed to the needs addressed by the product (therapeutic), the design aspects of the product, and the architectural aspects of the product. The categories may be chosen as desired to reflect different aspects or components of a product, a line of products, or of a combination of several products grouped to form an ensemble.

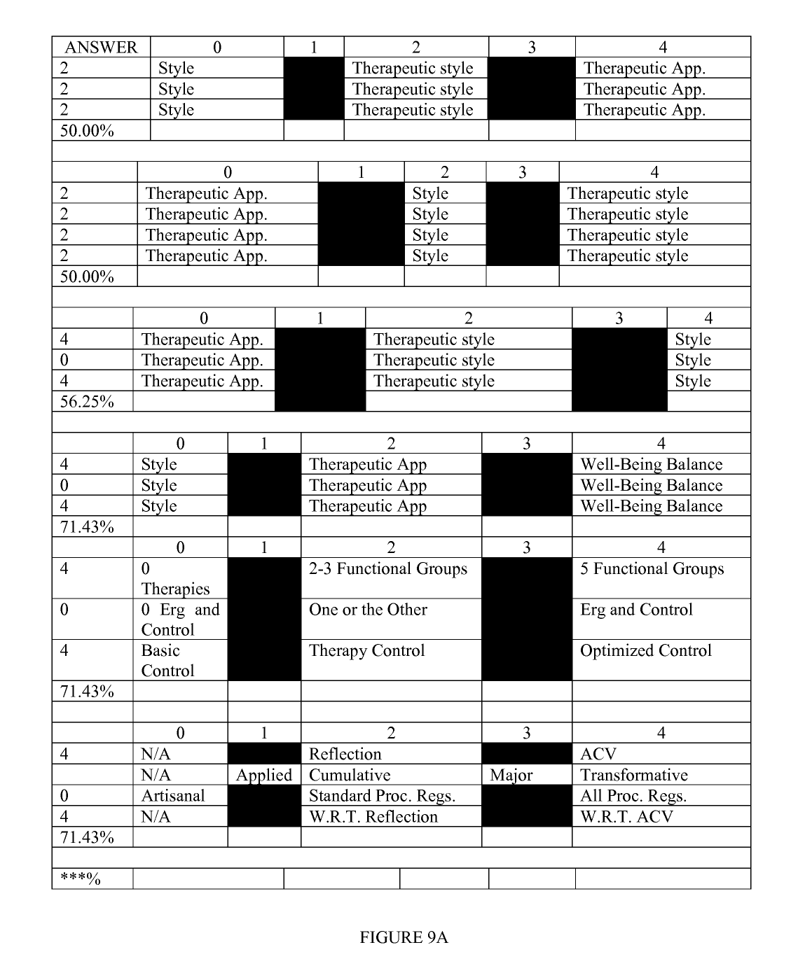

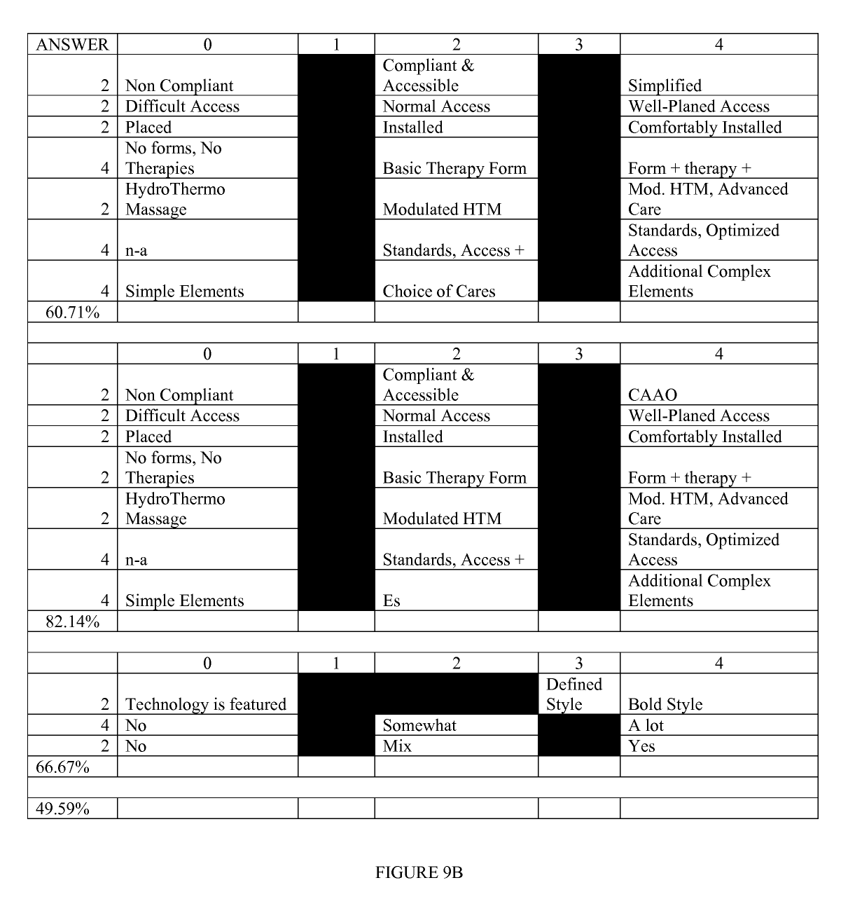

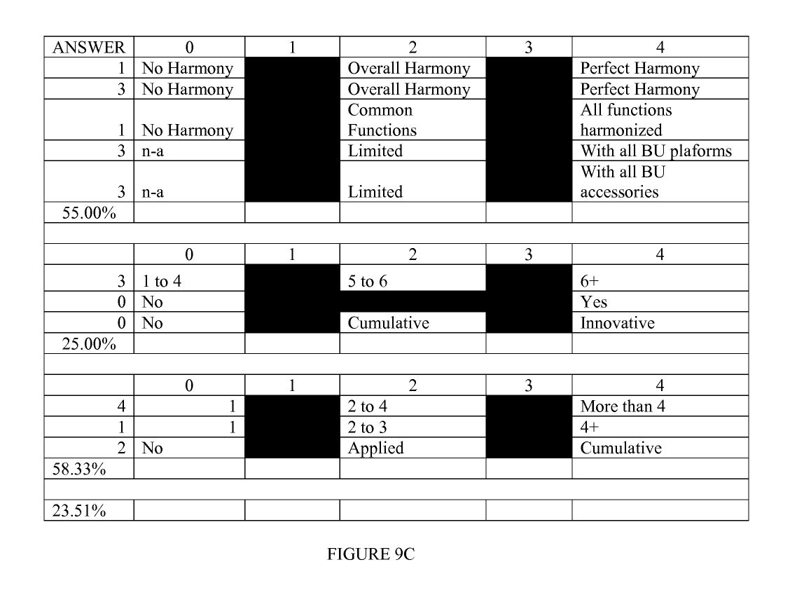

FIGS. 9a, 9b, 9c illustrate exemplary answers and scoring for the questions found in FIGS. 8a, 8b, and 8c. An answer format similar to that illustrated above with respect to FIGS. 3a, 3b, and 3c may be used. Alternatively, a different answer and/or scoring format may be used. In addition, the number of categories, sub-categories, and questions used for product mapping may differ from the number of categories, sub-categories, and questions used for living environment evaluation.

Referring back to FIG. 7, once the scores for each category are calculated, they are positioned in a multi-dimensional coordinate system. This multi-dimensional coordinate system will have the number of dimensions that corresponds to the number of categories used for the product-mapping questions, each dimension having a corresponding axis. However, an intersecting point, or center of the coordinate system, will represent a score of 0%, and the axes will have progressively increasing scales.

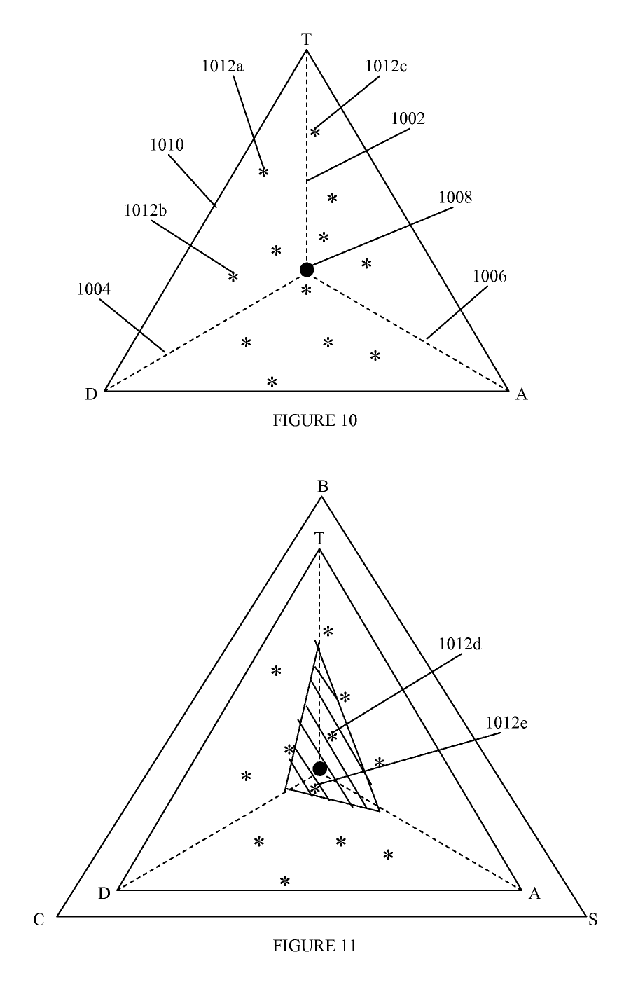

FIG. 10 illustrates an exemplary mapping of a variety of products within a three-dimensional coordinate system. Three axes 1002, 1004, 1006 form the coordinate system, and a center position 1008 represents the score of 0%. The triangle 1010 formed by joining the end of each axis 1002, 1004, 1006 together therefore defines the space within which the products will be mapped, as each vertex of the triangle 1010 represents a score of 100%.

The products are mapped in the coordinate system by locating the position (Tᵢ, Dᵢ, Aᵢ) that matches the three scores calculated for the three categories, and positioning a point in that position in the coordinate system 708 (FIG. 7). All of the products are mapped into the same coordinate system, as illustrated by the stars 1012a, 1012b, 1012c, etc.

As per FIG. 7, super-imposing the product mapping onto the surface is done by aligning the two coordinate systems together such that their center points 408, 1008 are aligned. The respective axes are also aligned. FIG. 11 illustrates the mapped products of FIG. 10 super-imposed onto the surface and coordinate system of FIG. 5a.

This super-positioning illustrates that there are only two products, namely those corresponding to 1012d and 1012e, that will address the specific needs found from the evaluation of the living environment. The consumer, when presented with this information, may select from these two products knowing that these needs are being addressed, and knowing which aspect or component is more catered to by the given product, as a function of its position in the coordinate system. For example, product 1012e would appear to address design and architectural issues, while product 1012d would appear to address therapeutic and design issues. If a therapeutic need is important, then product 1012d may be better suited for the individual.

Alternatively, the super-imposing may be done internally, by the merchant only, to know which product is more suitable for a given consumer, and only those products are presented as valid options to this consumer.

FIG. 12 illustrates an exemplary embodiment of a computer system for evaluating a living environment in accordance with the methods described above. The computer system 1200 comprises an application 1206 running on a processor 1204, the processor being coupled to a memory 1202. A user interface 1208 is connected to the computer system 1200. The user interface may comprise a keyboard, a display, and any other known user interface components used for interacting with a computer system. For example, a display may be used for input and output, if the screen is a touch screen. In another example, the user interface is a system that captures sensory data from the user as input. Various other embodiments will be readily understood by those skilled in the art.

The memory 1202 accessible by the processor 1204 receives and stores data, such as questions, responses, scores, coordinate systems, surfaces, product mapping data, and any other information used by the computer system 1200. The memory 1202 may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc.

The processor 1204 may access the memory 1202 to retrieve data. The processor 1204 may be any device that can perform operations on data. Examples are a central processing unit (CPU), a front-end processor, a microprocessor, a graphics processing unit (GPU/VPU), a physics processing unit (PPU), a digital signal processor, and a network processor. The application 906 is coupled to the processor 904 and configured to perform various tasks as explained below in more detail. An output may be transmitted to a display device 908.

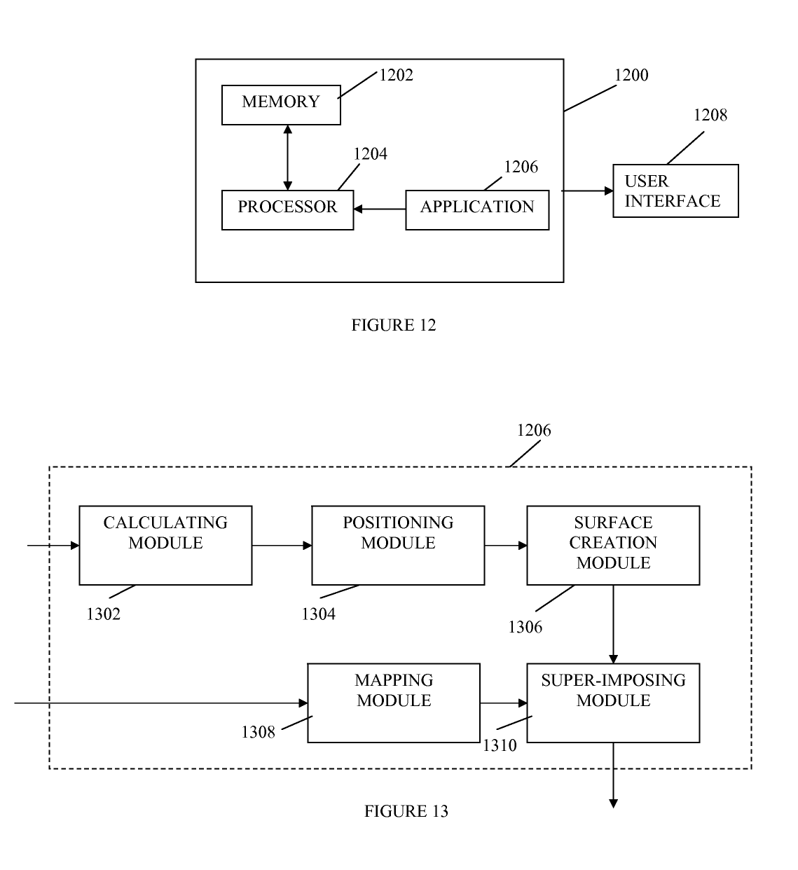

FIG. 13 illustrates an exemplary embodiment for the application 1206 of the computer system 1200 of FIG. 12. A calculating module 1302 retrieves data from memory 1202 and calculates, for each category, a score as a function received answers and associated weights. These scores are passed on to a positioning module 1304, which positions the score on the multi-dimensional coordinate system. The surface creation module 1306 may then create the surface from the positioned scores.

In one embodiment, the application 1206 also comprises a mapping module 1308 for retrieving from memory 1202 data used to map the products onto another coordinate system, and then passes the mapping along to a super-imposing module 1310, which combines the mapping data with surface data receiving from the surface creation module 1306 to overlay the two sets of data. This overlaid image is then output to an output display.

In one embodiment, the calculating module 1302 may be used to calculate the scores for both the environment evaluation and the product mapping, and the positioning module 1304 may be used to position the scores on both coordinate systems. The mapping module 1308 would therefore not be present and the super-imposing module 1310 may be connected to the surface creation module 1306 and the positioning module 1304.

Images output by the computer system 1200, as illustrated in FIGS. 4a, 4b, 4c, 4d, 5a, 5b, 10, and 11, may be provided with rotation and translation capabilities such that the volumes of the multi-dimensional coordinate systems can be viewed from different perspectives. In addition, the images may be color-coded to aide visualizing.

It should be understood that the modules illustrated in FIG. 13 may be provided in a single application 1206 or a combination of two or more applications coupled to the processor 1204. While illustrated in the block diagrams of FIGS. 12 and 13 as groups of discrete components communicating with each other via distinct data signal connections, it will be understood by those skilled in the art that the embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiments.

The embodiments of the invention described above are intended to be exemplary only. The scope of the invention is therefore intended to be limited solely by the scope of the appended claims.

I/We claim:

1. A computer-implemented method for evaluating a living environment having a plurality of elements therein, the method comprising:
presenting, via a user interface, a first series of questions, the questions being divided into at least three first categories, each first category having at least one question associated thereto, each question having a plurality of answers with varying weights associated thereto, each first category corresponding to an aspect of the living environment;
storing in a memory received answers for the first series of questions; and
using a processor for:
calculating, for each first category, a score as a function of received answers and associated weights;
positioning the score for each first category as a point on a corresponding axis in a first multi-dimensional coordinate system, the intersection of all axes representing a score of 100% and each axis having progressively decreasing values extending from said intersection;
creating a surface in the first multi-dimensional coordinate system by joining the points on each axis together, the size and shape of the surface representing a degree to which each aspect of the environment is met; and
outputting the surface to the user interface.

2. The computer-implemented method of claim 1, further comprising using the processor for super-imposing on said surface a mapping of a plurality of products as a function of how each one of the products corresponds to at least three second categories, as positioned within a second multi-dimensional coordinate system.

3. The computer-implemented method of claim 2, wherein the super-imposing comprises:
presenting, via the user interface, a second series of questions divided into the at least three second categories, each second category corresponding to an aspect of the products and having at least one question associated thereto, each question having a plurality of answers with varying weights associated thereto;
storing in a memory received answers for the second series of questions; and
using a processor for:
calculating, for each second category, a score as a function of received answers and associated weights for each one of the products;
positioning a single point for each score on the second multi-dimensional coordinate system formed of an axis for each one of the at least three second categories, an intersection of all axes representing a score of zero and each axis having progressively increasing values extending from said intersection; and
aligning the intersection of the first multi-dimensional coordinate system with the intersection of the second multi-dimensional coordinate system to overlay the single points for each product with the surface.

4. The computer-implemented method of claim 1, wherein the at least three first categories comprise a first category having questions related to physical, mental, emotional, and energetic aspects of the living environment, a second category having questions related to contents of the environment, and a third category having questions related to an area and a layout of the environment.

5. The computer-implemented method of claim 4, wherein the at least three first categories comprise a fourth category having questions related to lighting effects, circulation, and movement of the environment, a fifth category having questions related to media elements in the environment, and a sixth category related to magnetic and electrostatic fields in the environment.

6. The computer-implemented method of claim 1, wherein the number of available responses varies per question.

7. The computer-implemented method of claim 1, wherein said answers are presented with weights ranging from 0 to 4.

8. The computer-implemented method of claim 1, wherein each first category is separated into a plurality of first sub-categories, each first sub-category having at least one question associated thereto, and the score for each first category is an average of a score of each first sub-category.

9. The computer-implemented method of claim 1, wherein the at least three second categories comprise a first category having questions related to therapeutic aspects of the products, a second category having questions related to design aspects of the product, and a third category having questions related to architectural aspects of the product.

10. The computer-implemented method of claim 9, wherein the therapeutic aspects correspond to the product's ability to meet physical, mental, emotional, and energetic needs of an individual, the design aspects relate to the product's ability to inspire positive feelings, and the architecture aspects relate to the product's ability to be integrated into an environment to favor relief from tension, health, and well-being.

11. A computer system for evaluating a living environment having a plurality of elements therein, comprising:
a user interface for presenting a first series of questions, the questions being divided into at least three first categories, each first category having at least one question associated thereto, each question having a plurality of answers with varying weights associated thereto, each first category corresponding to an aspect of the living environment;
a memory for storing received answers for the first series of questions;
a processor; and
an application coupled to the processor and configured for:
calculating, for each first category, a score as a function of received answers and associated weights;
positioning the score for each first category as a point on a corresponding axis in a first multi-dimensional coordinate system, the intersection of all axes representing a score of 100% and each axis having progressively decreasing values extending from said intersection;
creating a surface in the first multi-dimensional coordinate system by joining the points on each axis together, the size and shape of the surface representing a degree to which each aspect of the environment is met; and
outputting the surface to the user interface.

12. The computer system of claim 11, wherein the application is further configured for super-imposing on said surface a mapping of a plurality of products as a function of how each one of the products corresponds to at least three second categories, as positioned within a second multi-dimensional coordinate system.

13. The computer system of claim 12, wherein the super-imposing comprises:
presenting, via the user interface, a second series of questions divided into the at least three second categories, each second category corresponding to an aspect of the products and having at least one question associated thereto, each question having a plurality of answers with varying weights associated thereto;
storing in a memory received answers for the second series of questions;
using a processor for:
calculating, for each second category, a score as a function of received answers and associated weights for each one of the products;
positioning a single point for each score on the second multi-dimensional coordinate system formed of an axis for each one of the at least three second categories, an intersection of all axes representing a score of zero and each axis having progressively increasing values extending from said intersection; and
aligning the intersection of the first multi-dimensional coordinate system with the intersection of the second multi-dimensional coordinate system to overlay the single points for each product with the surface.

14. The computer system of claim 11, wherein the at least three first categories comprise a first category having questions related to physical, mental, emotional, and energetic aspects of the living environment, a second category having questions related to an area and a layout of the environment, and a third category having questions related to contents of the environment.

15. The computer system of claim 14, wherein the at least three first categories comprise a fourth category having questions related to lighting effects, circulation, and movement of the environment, a fifth category having questions related to media elements in the environment, and a sixth category related to magnetic and electrostatic fields in the environment.

16. The computer system of claim 11, wherein the number of available responses varies per question.

17. The computer system of claim 11, wherein said answers are presented with weights ranging from 0 to 4.

18. The computer system of claim 11, wherein each first category is separated into a plurality of first sub-categories, each first sub-category having at least one question associated thereto, and the score for each first category is an average of a score of each first sub-category.

19. The computer system of claim 11, wherein the at least three second categories comprise a first category having questions related to therapeutic aspects of the products, a second category having questions related to design aspects of the product, and a third category having questions related to architectural aspects of the product.

20. The computer system of claim 19, wherein the therapeutic aspects correspond to the product's ability to meet physical, mental, emotional, and energetic needs of an individual, the design aspects relate to the product's ability to inspire positive feelings, and the architecture aspects relate to the product's ability to be integrated into an environment to favor relief from tension, health, and well-being.

21. A computer readable memory having recorded thereon statements and instructions for execution by a computer to carry out a method for evaluating a living environment having a plurality of elements therein, the statements and instructions being directed to:
presenting, via a user interface, a first series of questions, the questions being divided into at least three first categories, each first category having at least one question associated thereto, each question having a plurality of answers with varying weights associated thereto, each first category corresponding to an aspect of the living environment;
calculating, for each first category, a score as a function of received answers and associated weights;
positioning the score for each first category as a point on a corresponding axis in a first multi-dimensional coordinate system, the intersection of all axes representing a score of 100% and each axis having progressively decreasing values extending from said intersection;
creating a surface in the first multi-dimensional coordinate system by joining the points on each axis together, the size and shape of the surface representing a degree to which each aspect of the environment is met; and
outputting the surface to the user interface.
